(19) United States
(12) Patent Application Publication
(10) Pub. No.: US 2026/0246324 A1
(43) Pub. Date: Aug. 20, 2026

(54) ROTOR CORE, ROTOR, AND ELECTRIC MOTOR

(71) Applicant: Fanuc Corporation, Minamitsuru-gun, Yamanashi (JP)

(72) Inventor: Ryuya YASUDA, Minamitsuru-gun, Yamanashi (JP)

(73) Assignee: Fanuc Corporation, Minamitsuru-gun, Yamanashi (JP)

(21) Appl. No.: 18/871,234

(22) PCT Filed: Jun. 22, 2022
(86) PCT No.: PCT/JP2022/024927

§ 371 Date: Dec. 3, 2024

(51) Int. Cl. H02K 1/276

(52) U.S. Cl. CPC H02K 1/276

(57) ABSTRACT

The present invention provides a rotor core provided with a plurality of pairs of magnet slots formed to assume a V shape. A plurality of holes are formed between each pair of magnet slots. A hole includes a general isosceles triangle with the vertex angle directed to the center of the rotor core and an arc connected to the base of the isosceles triangle. At least a part of the arc is positioned, in a radial direction of the rotor core, on an outer side of a first line segment connecting outermost portions of the magnet slots.

### CROSS REFERENCE TO RELATED APPLICATIONS

This is the U.S. National Phase application of PCT/JP 2022/024927, filed Jun. 22, 2022, the disclosure of this application being incorporated herein by reference in its entirety for all purposes.

### FIELD OF THE INVENTION

Embodiments of the present invention relate to a rotor core, a rotor, and an electric motor.

### BACKGROUND OF THE INVENTION

A plurality of pairs of magnet slots which are arranged in a V-shape are formed in an end surface of a rotor core of a motor, and magnets are inserted into each magnet slot. In order to reduce the weight and inertia of the rotor core, holes are formed in the rotor core (refer to, for example, Japanese Patent No. 6987310). However, if holes are formed inside each pair of magnet slots which are arranged in a V-shape, the flow of magnetic flux is impeded, whereby torque is reduced.

### PATENT LITERATURE

PTL 1: Japanese U.S. Pat. No. 6,987,310

### SUMMARY OF THE INVENTION

In order to increase torque, it is possible to extend the V-shaped tip of each pair of magnet slots radially inward of the core. However, in this case, the area of the rotor core in which holes can be formed becomes smaller. As a result, it is difficult to reduce weight and inertia.

Thus, there is a demand for a lightweight rotor core, rotor, and electric motor which can reduce inertia without reducing torque.

According to a first aspect of the present disclosure, there is provided a rotor core, wherein a plurality of pairs of magnet slots extending in an axial direction of the rotor core are formed in the rotor core, the plurality of pairs of magnet slots are arranged at equal intervals in a circumferential direction of the rotor core in a radial cross-section of the rotor core, each pair of magnet slots of the plurality of pairs of magnet slots includes a first magnet slot which is inclined counterclockwise relative to a radius of the rotor core and a second magnet slot which is inclined clockwise relative to the radius of the rotor core, a plurality of holes extending in the axial direction of the rotor core are further formed between the first magnet slot and the second magnet slot in each pair of magnet slots, in the radial cross-section of the rotor core, each of the plurality of holes is constituted by an approximately isosceles triangle an apex angle of which faces a center of the rotor core and an arc protruding from a base of the isosceles triangle toward a radially outer side of the rotor core, and at least one portion of the arc in each of the plurality of holes in the radial cross-section of the rotor core is positioned on the radially outer side of the rotor core relative to a first line segment between a portion of the first magnet slot positioned at the outermost position of the rotor core and a portion of the second magnet slot positioned at the outermost position of the rotor core.

The objects, features, and advantages of the present invention will become more apparent from the following detailed description of the embodiments in conjunction with the accompanying drawings.

### BRIEF DESCRIPTION OF DRAWINGS

FIG. 1 is an axial cross-sectional view of an electric motor according to a first embodiment of the present invention.

FIG. 2 is a radial cross-sectional view of a rotor of an electric motor based on the first embodiment.

FIG. 3 is an enlarged view of a first portion of the rotor shown in FIG. 2.

FIG. 4 is an enlarged view of a second portion of the rotor shown in FIG. 2.

FIG. 5 is an enlarged view of a third portion of the rotor shown in FIG. 2.

FIG. 6A is a cross-sectional view showing a portion of magnetic flux of an electric motor of the prior art.

FIG. 6B is a view showing the relationship between time and torque of an electric motor of the prior art.

FIG. 7A is a cross-sectional view showing a portion of the magnetic flux of an electric motor based on the first embodiment.

FIG. 7B is a view showing the relationship between time and torque of an electric motor based on the first embodiment.

FIG. 8 is a radial cross-sectional view of a rotor core of an electric motor based on the first embodiment.

### DETAILED DESCRIPTION OF EMBODIMENTS OF THE INVENTION

The embodiments of the present invention will be described below with reference to the attached drawings. In the drawings, corresponding constituent elements have been assigned common reference signs.

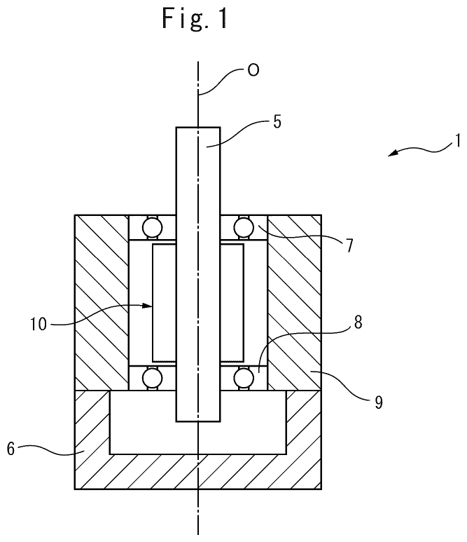

FIG. 1 is an axial cross-sectional view of an electric motor based on a first embodiment of the present invention. As shown in FIG. 1, the electric motor 1 comprises a stator 9 and a rotor 10 which is rotatably supported by the stator 9. A first bearing 7 and a second bearing 8 are arranged on the inner peripheral surface of the stator 9. A shaft 5 which passes through the rotor 9 is rotatably supported on the stator 9 by the first bearing 7 and the second bearing 8. A detector 6 for detecting the rotation speed of the shaft 5 or the like is attached to one end of the stator 9.

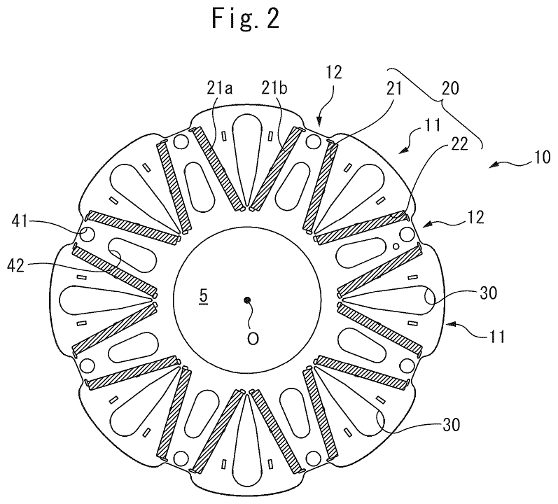

FIG. 2 is a radial cross-sectional view of a rotor of an electric motor based on the first embodiment. The rotor 10 shown in FIG. 2 is substantially annular and comprises a through hole in the center thereof for the shaft 5. However, as will be described later, it is preferable that the outer circumferential surface of the rotor 10 not be smooth.

A plurality of pairs of magnet slots 20 extending in the axial direction of the rotor 10 are formed in the rotor 10 at equal intervals in the circumferential direction. Each pair of magnet slots 20 includes a first magnet slot 21 which is inclined counterclockwise relative to the radius of the rotor 10, and a second magnet slot 22 which is inclined clockwise relative to the radius of the rotor 10. It is preferable that the absolute values of the inclination angles of the first magnet slot 21 and the second magnet slot 22 relative to the radius be equal to each other.

Permanent magnets 21a, 21b are inserted into the magnet slots 21, 22, respectively. Thus, the magnet slots 21, 22 are preferably substantially rectangular in shape corresponding to the shapes of the permanent magnets 21a, 21b, and are preferably the same shape as each other. Furthermore, it is preferable that additional notches or the like be formed in the magnet slots 21, 22 in order to facilitate insertion/removal of the permanent magnets 21a, 21b.

The magnet slots 21, 22 are arranged so as to converge toward each other toward the radially inner side of the rotor 10. In other words, the magnet slots 21, 22 are formed so as to form a substantial V-shape. However, the magnet slots 21, 22 need not be connected to each other on the radially inner side.

In FIG. 2, the outer periphery of the rotor 10 is composed of a plurality of first outer peripheries 11 and a plurality of second outer peripheries 12 connecting the plurality of first outer peripheries 11. Specifically, the plurality of first outer peripheries 11 and the plurality of second outer peripheries 12 are alternately arranged in the circumferential direction of the rotor 10. As can be understood from FIG. 2, the plurality of first outer peripheries 11 correspond to the respective regions of the plurality of pairs of magnet slots 20. The plurality of second outer peripheries 12 each correspond to the respective regions between two adjacent pairs of magnet slots 20 among the plurality of pairs of magnet slots 20.

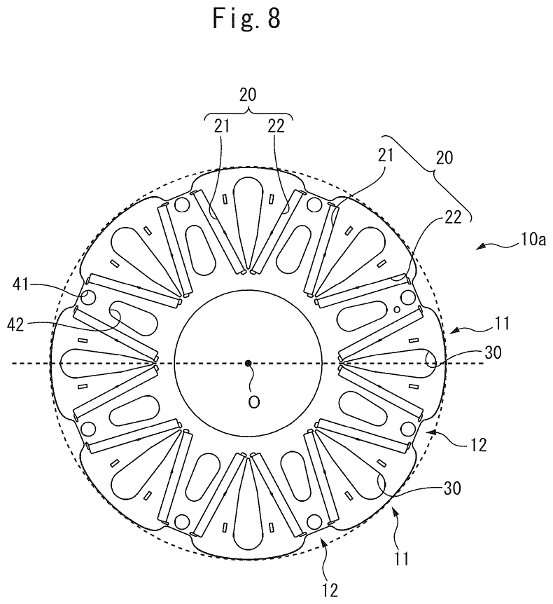

The outermost portion of the first outer periphery 11 is positioned on the radially outer side of the rotor 10 relative to the outermost portion of the second outer periphery 12. In other words, the first outer periphery 11 as convex portions and the second outer periphery 12 as concave portions are alternately arranged in the circumferential direction of the rotor 10. The entire first outer periphery 11 is positioned inside a circle (represented by the dashed line in FIG. 8, which will be described later) having a radius of a line segment connecting the center O of the rotor 10 and the outermost portion of the first outer periphery 11. It is preferable that the outermost portion of the second outer periphery 12 be positioned on the radially outer side of the rotor 10 relative to the permanent magnet 21b of one pair and the permanent magnet 21a of the other pair of the two pairs of magnet slots 20 adjacent to the second outer periphery 12.

In this manner, since the outer periphery of the rotor 10 is not a perfect circle, change in magnetic flux linkage is small when the electric motor 1 comprising the rotor 10 is driven, and as a result, it is possible to prevent cogging torque and torque ripple from increasing. Thus, in the first embodiment of the present invention, it is possible to improve the controllability of the electric motor 1 comprising the rotor 10.

In FIG. 2, each of the outermost portions of the first outer peripheries 11 is composed of at least one curve. In one example, the first outer periphery 11 is defined by the formula r=D-E/cos(Fθ) (where D, E, and F are positive numbers). In this case, the first outer periphery 11 is reliably positioned inside the aforementioned circle and is smooth.

Each of the outermost portions of the second outer peripheries 12 is composed of at least one straight line. In the illustrated embodiment, the outermost portion of the second outer periphery 12 includes a straight line that is substantially parallel to one side of the permanent magnet 21a of one pair of the two pairs of magnet slots 20 adjacent to the second outer periphery 12 and one side of the permanent magnet 21b of the other pair.

In an unillustrated embodiment, the outermost portion of the first outer periphery 11 may be formed by at least one straight line, and the outermost portion of the second outer periphery 12 may be formed by at least one curved line. Both the outermost portion of the first outer periphery 11 and the outermost portion of the second outer periphery 12 may be formed by at least one straight line, or both the outermost portion of the first outer periphery 11 and the outermost portion of the second outer periphery 12 may be formed by at least one curved line. Further, at least one of the outermost portion of the first outer periphery 11 and the outermost portion of the second outer periphery 12 may be formed by at least one straight line and at least one curved line. In such a case, since the outermost portions of the first outer peripheries 11 are positioned on the radially outer side of the rotor 10 relative to the outermost portions of the second outer peripheries 12, the outer circumference of the rotor 10 has a shape different from a perfect circle. Thus, it should be understood that the same effects as described above can be obtained.

In a modification example of the first embodiment (not illustrated), the first outer periphery 11 may be positioned radially inward of the rotor 10 relative to the second outer periphery 12. Even in such a case, the same effects as those described above can be obtained and are included in the scope of the first embodiment.

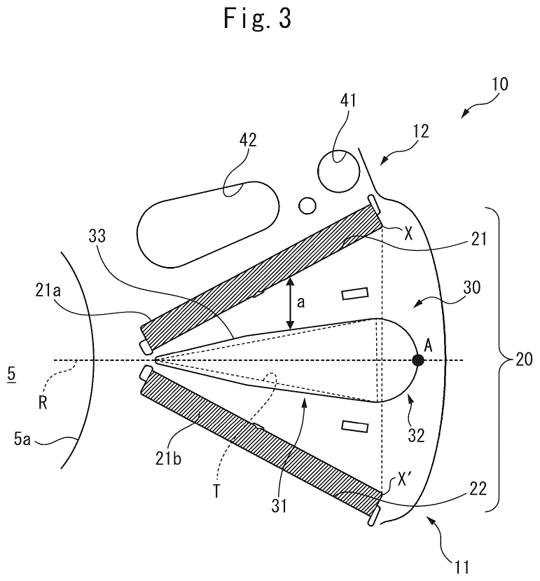

As shown in FIG. 2, a plurality of holes 30 extending in the axial direction of the rotor 10 are formed in the end surface of the rotor 10 at equal intervals in the circumferential direction. FIG. 3 is an enlarged view of the first portion of the rotor shown in FIG. 2. As can be understood from FIGS. 2 and 3, each of the plurality of holes 30 is formed in a region of the rotor 10 corresponding to the first outer periphery 11. Strictly speaking, the hole 30 is formed between the first magnet slot 21 and the second magnet slot 22 of the pair of magnet slots 20. The shape of the hole 30 will be described later.

Likewise, a plurality of sets of holes 41, 42 extending in the axial direction of the rotor 10 are formed in the end surface of the rotor 10 at equal intervals in the circumferential direction. As can be understood from FIGS. 2 and 3, each of the plurality of sets of holes 41, 42 is formed in a region of the rotor 10 corresponding to the second outer periphery 12. The hole 41 is formed in the radially outer side of the rotor 10 relative to the hole 42, and the hole 41 is smaller than the hole 42. In one example, the hole 41 is circular, and the hole 42 is an ellipse the width of which decreases from the inner side to the outer side in the radial direction of the rotor 10. Alternatively, at least one of the holes 41, 42 may be elliptical or oval.

The shapes of the holes 30 will be described below. As shown in FIG. 3, each hole 30 is composed of a first portion 31 and a second portion 32 positioned on the radially outer side of the rotor 10 relative to the first portion 31. The center lines of the first portion 31 and the second portion 32 are positioned on one radius R of the rotor 10. It should be noted that the “radius R” in the present description is one portion of a straight dashed line extending from the center O of the rotor 10 and passing through the center line of the hole 30 in FIG. 8, which will be described later. In other words, the “radius R” is a line segment connecting the center O of the rotor 10 and the edge of the first outer periphery 11 from the center O.

As shown in FIG. 3, the first portion 31 has a shape of an approximately isosceles triangle T the apex angle of which faces the center O of the rotor 10. The second portion 32 has a shape of an arc, for example a semicircle, protruding from the base of the isosceles triangle T to the radially outer side of the rotor 10. It is preferable that the first portion 31 and the second portion 32 be smoothly connected to each other.

The reason for using the term “approximately isosceles triangle” is that it includes cases that are different from a perfect isosceles triangle, such as when the apex portion of the isosceles triangle T is rounded, when each of the two hypotenuses 33 of the isosceles triangle T is composed of a plurality of straight lines, and when each of the two hypotenuses 33 of the isosceles triangle T includes a curve. Furthermore, the arc as the second portion 32 may be longer or shorter than the arc of a semicircle. Furthermore, the arc as the second portion 32 may be an elliptical arc.

In FIG. 3, in one pair of magnet slots 20, one portion of the first magnet slot 21 positioned at the outermost side of the rotor 10 is designated as “X”, and one portion of the magnet slot 22 positioned at the outermost side of the rotor 10 is designated as “X′.” At least one portion of the arc as the second portion 32, for example, point A, is positioned on the radially outer side of the rotor 10 relative to the straight line XX′.

In this manner, since at least one portion of the hole 30 is positioned more on the radially outer side of the rotor 10 than the straight line XX′, the length of the hole 30 on the radius R is longer than the length of one surface of the permanent magnets 21a, 21b facing the hole 30 (corresponding to the width of the permanent magnets). Thus, in the first embodiment, a large hole 30 can be formed, and as a result, the rotor 10 can be made lighter and the electric motor 1 can be made faster. Furthermore, since the second portion 32 is an arc, the flow of magnetic flux is not impeded when the electric motor 1 comprising the rotor 10 is driven.

As described above, it is preferable that the first outer periphery 11 in which the hole 30 is formed protrude further toward the radially outer side of the rotor 10 than the second outer periphery 12. In this case, the hole 30 can be formed so as to be longer in the radial direction of the rotor 10 by the protruding portion of the first outer periphery 11. Thus, it should be understood that the hole 30 can be made larger and the rotor 10 can be made lighter.

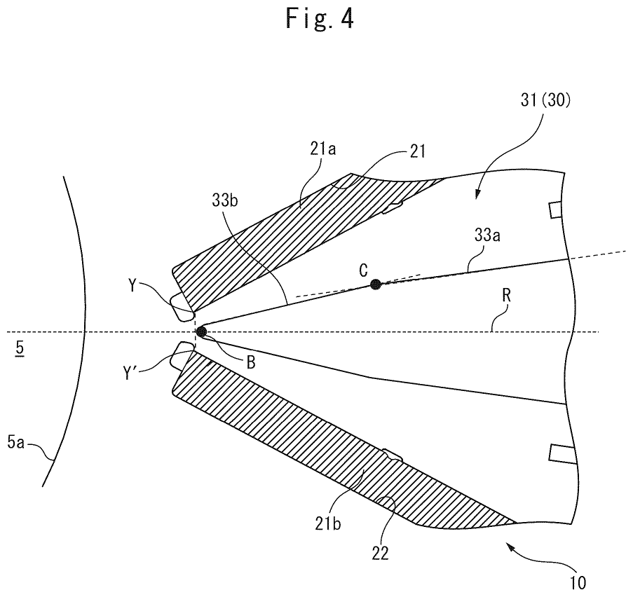

FIG. 4 is an enlarged view of the second portion of the rotor shown in FIG. 2. In FIG. 4, each hypotenuse 33 of the first portion 31 of the hole 30 has a first straight section 33a extending from the base of the approximately isosceles triangle T and a second straight section 33b extending from the distal end of the first straight section 33a toward a point B at the apex of the approximately isosceles triangle T. As can be understood with reference to FIGS. 3 and 4, the first straight section 33a is connected to the second portion 32. The intersection point B between the two second straight sections 33b may be rounded.

In FIG. 4, the first straight section 33a and the second straight section 33b intersect at an intersection C. As can be understood with reference to FIGS. 3 and 4, the intersection Cis positioned outside the approximately isosceles triangle T relative to the hypotenuse corresponding to the intersection C. In other words, the angle formed by the radius R and the first straight section 33a shown in FIG. 4 is smaller than the angle formed by the radius R and the second straight section 33b.

Thus, the first portion 31 having the shape described above is larger than the first portion 31 as a perfect isosceles triangle T. Therefore, the hole 30 is larger, and the rotor 10 can accordingly be made lighter. Although the second straight section 33b extends from the vicinity of point B so as to enlarge the hole 30, the first straight section 33a extends so as to suppress the enlargement of the hole 30. In other words, it is preferable that the hole 30 be formed so as to be larger on the radially inner side of the rotor 10 and smaller on the radially outer side of the rotor 10. This prevents the hole 30 from becoming excessively large, and suppresses the flow of magnetic flux on the radially outer side of the rotor 10 from being impeded.

In FIG. 4, in the pair of magnet slots 20, one portion of the first magnet slot 21 that is closest to the radius R is designated as “Y”, and one portion of the second magnet slot 22 that is closest to the same radius R is designated as “Y′.” The apex B on the apex angle side of the approximately isosceles triangle T is positioned near the straight line YY′. The apex B may be positioned at the intersection of the straight line YY′ and the radius R, or may be positioned radially inward of the rotor 10 relative to the straight line YY′. In this manner, since the end of the hole 30 positioned radially inward of the rotor 10 is positioned near the straight line YY′, the hole 30 can be made larger, and as a result, the rotor 10 can be made lighter.

It is preferable that the apex B be positioned more on the radially outer side of the rotor 10 than the straight line YY′. This can ensure the strength of the rotor 10. When the rotor 10 is formed by stacking a plurality of magnetic plates in the axial direction of the rotor 10, the above configuration is particularly preferable because it can ensure the strength of the plurality of magnetic plates.

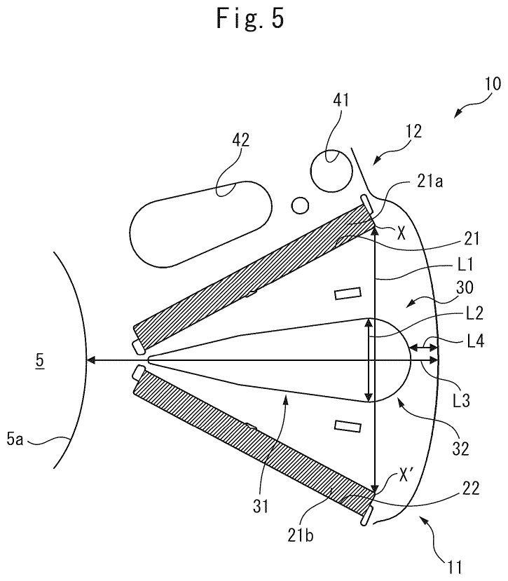

FIG. 5 is an enlarged view of a third portion of the rotor shown in FIG. 2. In the example shown in FIG. 5, the maximum width L2 of the hole 30 perpendicular to the radius R (refer to FIGS. 3 and 4) substantially corresponds to the base of the approximately isosceles triangle T described above.

This maximum width L2 is preferably ⅓ or less of the length L1 of the straight line XX′. This makes it possible to prevent the hole 30 from becoming excessively large, while suppressing the impedance of the flow of magnetic flux on the radially outer side of the rotor 10.

The line segment L3 shown in FIG. 5 is the length between the edge 5a of the through hole of the rotor 10 into which the shaft 5 is inserted and the outermost portion of the rotor 10, and represents the length of one portion on the radius R described above. The line segment L4 represents the length between the outermost portion of the hole 30 in the radial direction of the rotor 10 and the outermost portion in the radial direction of the rotor 10. In other words, the line segment L4 is the shortest distance between the first outer periphery 11 and the second portion 32 of the hole 30.

In FIG. 5, the length of the line segment L3 is preferably shorter than 10 times the length of the line segment L4. In one example, the length of the line segment L3 is 10 times the length of the line segment L4. In such a case, the flow of the magnetic flux on the radially outer side of the rotor 10 can be prevented from being impeded while maintaining the size of the hole 30.

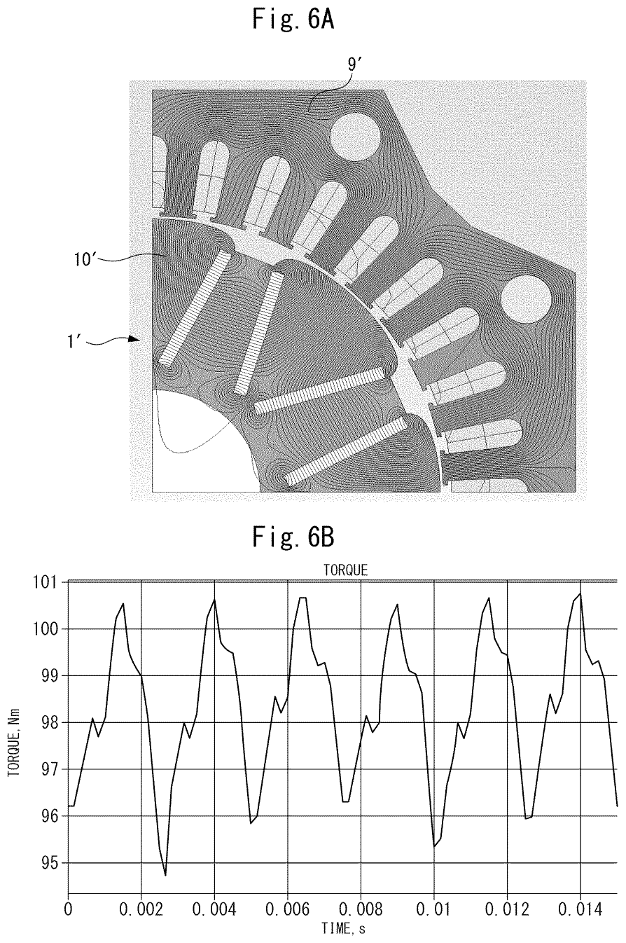

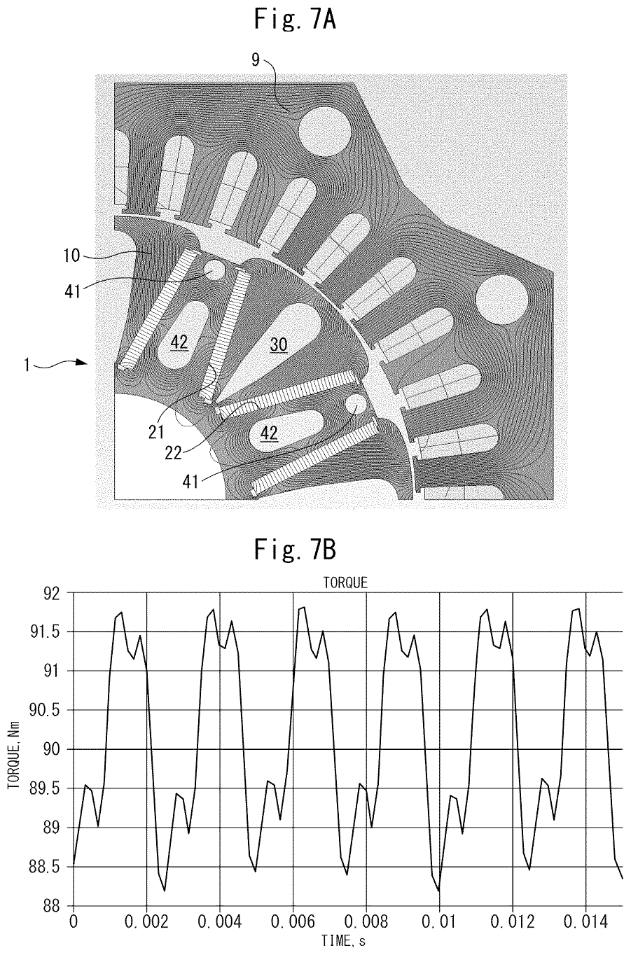

FIG. 6A is a partial cross-sectional view showing the magnetic flux of an electric motor of the prior art, and FIG. 7A is a partial cross-sectional view showing the magnetic flux of an electric motor based on the first embodiment. The electric motor 1′ shown in FIG. 6A comprises a stator 9′ and a rotor 10′. The electric motor 1 shown in FIG. 7A comprises a stator 9 and the rotor 10 described above. Since the structures of the rotors 10 and 10′ are well known, description thereof has been omitted. As can be understood by comparing FIG. 6A and FIG. 7A, even if the holes 30, 41, and 42 are formed in the manner of the electric motor 1, the flow of magnetic flux is not impeded by the holes 30 or the like. Furthermore, the electric motor 1 is lighter than the electric motor 1′ by the amount for forming the holes 30, 41, and 42.

FIG. 6B is a view showing the relationship between time and torque of an electric motor of the prior art, and FIG. 7B is a view showing the relationship between time and torque of an electric motor based on the first embodiment. In these drawings, the horizontal axis represents time, and the vertical axis represents the torque of electric motors 1 and 1′. In FIG. 6B, the maximum torque value of the electric motor 1′ is between 100 Nm and 101 Nm. In contrast thereto, in FIG. 7B, the maximum torque value of the electric motor 1 is between 91.5 Nm and 92 Nm. Specifically, even when holes 30, 41, and 42 are formed, the decrease in torque is suppressed to less than 10%.

Even when the holes 30, 41, and 42 are formed in this manner, the torque is not significantly reduced and a practical torque can be generated. It would be apparent to a person skilled in the art that the same effects can be obtained even when only the hole 30 of the first embodiment is formed.

Thus, in the first embodiment of the present invention, the rotor 10 is made lighter by forming the holes 30, and inertia can be reduced without a significant decrease in torque. Specifically, it is possible to provide a lightweight rotor 10 that can reduce inertia without a decrease in torque. Therefore, high acceleration of the electric motor 1 comprising the rotor 10 can be achieved.

FIG. 8 is a radial cross-sectional view of a rotor core of an electric motor based on the first embodiment. The rotor core 10a of the rotor 10 shown in FIG. 8 is the rotor 10 shown in FIG. 2 with all the permanent magnets 21a, 21b and the rotor 5 removed. Other elements shown in FIG. 8 are identical to those described with reference to FIG. 2. Such a rotor core 10a shown in FIG. 8 and the electric motor 1 shown in FIG. 1, etc., are also included in the scope of the first embodiment of the present invention.

Although the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

### REFERENCE SIGNS LIST

1 electric motor
5 shaft
9 stator
10 rotor
10a rotor core
11 first outer periphery
12 second outer periphery
20 magnet slot
21 first magnet slot
22 second magnet slot
21a, 21b permanent magnet
30 hole
31 first portion
32 second portion
33 hypotenuse
33a first straight section
33b second straight section
41, 42 hole
T approximately isosceles triangle

1. A rotor core, wherein
a plurality of pairs of magnet slots extending in an axial direction of the rotor core are formed in the rotor core,
the plurality of pairs of magnet slots are arranged at equal intervals in a circumferential direction of the rotor core in a radial cross-section of the rotor core,
each pair of magnet slots of the plurality of pairs of magnet slots includes a first magnet slot which is inclined counterclockwise relative to a radius of the rotor core and a second magnet slot which is inclined clockwise relative to the radius of the rotor core,
a plurality of holes extending in the axial direction of the rotor core are further formed between the first magnet slot and the second magnet slot in each pair of magnet slots,
in the radial cross-section of the rotor core, each of the plurality of holes is constituted by an approximately isosceles triangle an apex angle of which faces a center of the rotor core and an arc protruding from a base of the isosceles triangle toward a radially outer side of the rotor core, and
at least one portion of the arc in each of the plurality of holes in the radial cross-section of the rotor core is positioned on the radially outer side of the rotor core relative to a first line segment between a portion of the first magnet slot positioned at the outermost position of the rotor core and a portion of the second magnet slot positioned at the outermost position of the rotor core.

2. The rotor core according to claim 1, wherein the outer periphery of the rotor core is composed of a plurality of first outer peripheries and a plurality of second outer peripheries connecting each of the plurality of first outer peripheries,
the plurality of first outer peripheries correspond to respective regions of the plurality of pairs of magnet slots,
the plurality of second outer peripheries correspond to regions between two pairs of magnet slots adjacent to each other among the plurality of pairs of magnet slots, and
outermost portions of the plurality of first outer peripheries are positioned on the radially outer side of the rotor core relative to the outermost portions of the plurality of second outer peripheries.

3. The rotor core according to claim 2, wherein
the plurality of first outer peripheries are formed by at least one curve, and
the plurality of second outer peripheries are formed by at least one straight line.

4. The rotor core according to claim 1, wherein each of the two hypotenuses of the approximately isosceles triangle has a first straight section extending from the base and a second straight section extending from a distal end of the first straight section toward an apex of the approximately isosceles triangle, and
an intersection between the first straight section and the second straight section is positioned outside the approximately isosceles triangle relative to the hypotenuse corresponding to the intersection.

5. The rotor core according to claim 1, wherein a length of the base of the approximately isosceles triangle is ⅓ or less a length of the first line segment.

6. The rotor core according to claim 1, wherein a through hole for a shaft to be inserted into the rotor core is formed, and
a length of a third line segment, which is positioned on the radius of the rotor core and connects the outer edge of the through hole to the first outer periphery, is shorter than ten times the distance from the first outer periphery to the arc on the third line segment.

7. A rotor comprising:
the rotor core according to claim 1,
a shaft inserted into the rotor core, and
magnets inserted into each of the pairs of magnet slots of the rotor core.

8. An electric motor comprising:
the rotor according to claim 7, and
a stator arranged around the rotor.
